(19) United States
(12) Patent Application Publication
(10) Pub. No.: US 2023/0279940 A1
(43) Pub. Date: Sep. 7, 2023

(54) GEAR BOX

(71) Applicant: MINEBEA MITSUMI Inc., Nagano (JP)

(72) Inventors: Koichiro HIRABAYASHI, Kitasaku-gun (JP); Yukimasa MATSUMURA, Kitasaku-gun (JP); Seiji MITAMURA, Kitasaku-gun (JP)

(21) Appl. No.: 18/176,654

(22) Filed: Mar. 1, 2023

(30) Foreign Application Priority Data
Mar. 3, 2022 (JP) 2022-032360

(51) Int. Cl. F16H 57/039; F16H 1/16

(52) U.S. Cl. CPC F16H 57/039; F16H 1/16

(57) ABSTRACT

A gear box includes a motor, a worm pivotally supported by a shaft of the motor, a gear being formed at the worm, and a helical gear configured to mesh with the gear of the worm. A transfer coefficient of the helical gear with respect to a standard gear is x, an addendum coefficient of the helical gear is k, x satisfies −0.4<x<−0.1, and k satisfies 0.1<k<0.4.

### TECHNICAL FIELD

The present invention relates to a gear box.

### BACKGROUND ART

A known gear box includes a motor, a worm attached to a rotating shaft of the motor, and a worm wheel meshing with a gear formed on the worm (see, for example, Patent Documents 1 and 2).

### CITATION LIST

### Patent Literature

Patent Document 1: JP 2007-315521 A

Patent Document 2: JP 2013-053648 A

### SUMMARY OF INVENTION

### Technical Problem

Unfortunately, simply meshing the gear formed on the worm with a helical gear as a worm wheel may cause sound at the time of driving the motor to become louder.

One aspect is to provide a gear box capable of reducing sound at the time of driving a motor.

### Solution to Problem

To solve the above-described problem and achieve an object, a gear box according to the present invention includes a motor, a worm pivotally supported by a shaft of the motor, a gear being formed at the worm, and a helical gear configured to mesh with the gear of the worm. A transfer coefficient of the helical gear with respect to a standard gear is x, an addendum coefficient of the helical gear is k, x satisfies −0.4<x<−0.1, and k satisfies 0.1<k<0.4.

One aspect can reduce sound at the time of driving a motor.

### BRIEF DESCRIPTION OF DRAWINGS

FIG. 1 is a plan view of a gear box according to an embodiment with a second part of a housing removed.

FIG. 2 is a side view of the gear box according to the embodiment.

FIG. 3 is a cross-sectional view illustrating an inside of the housing according to the embodiment.

FIG. 4 is a plan view illustrating main parts of the gear box according to the embodiment.

FIG. 5 is a cross-sectional view for explaining terms representing the shape of a gear.

### DESCRIPTION OF EMBODIMENTS

An embodiment of a gear box is described below in detail with reference to the drawings. Note that the dimensional relationship of elements and the ratio of the elements in the drawings may differ from an actual configuration. The drawings may each include parts having mutually different dimensional relationships and proportions. For ease of description in each drawing, a direction of an axial center 3x of a shaft 31 of a motor 3 described below extending is referred to as an X-axis direction, a direction orthogonal to the X-axis direction is referred to as a Y-axis direction, and a direction orthogonal to the X-axis direction and the Y-axis direction is referred to as a Z-axis direction.

### EMBODIMENTS

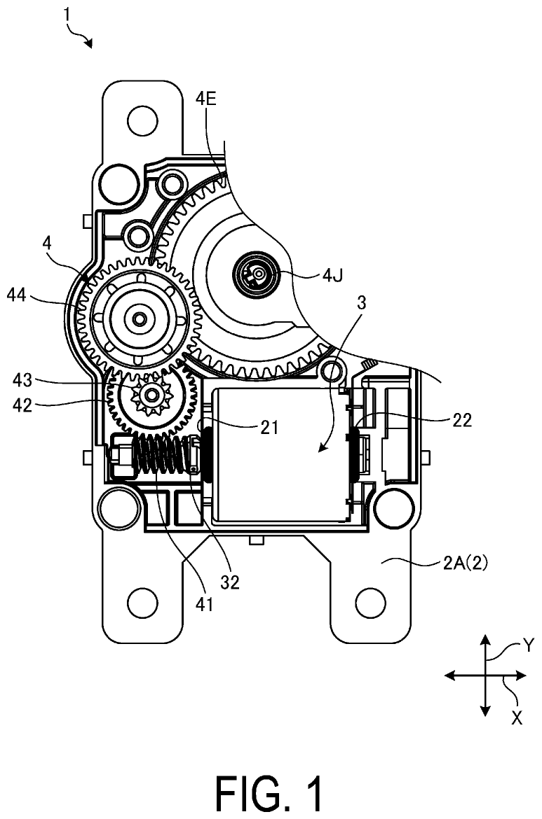

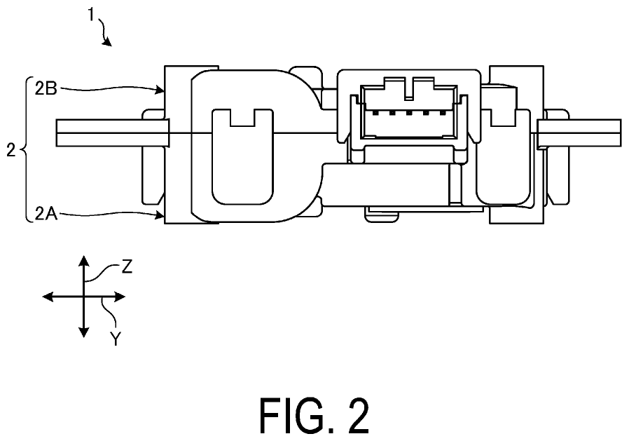

FIG. 1 is a plan view of a gear box 1 according to the embodiment with a second part 2B of a housing 2 removed. FIG. 2 is a side view of the gear box 1 according to the embodiment.

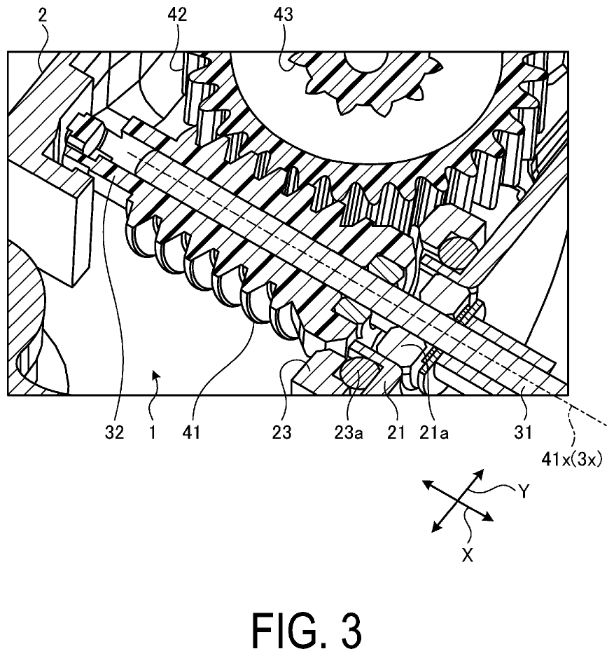

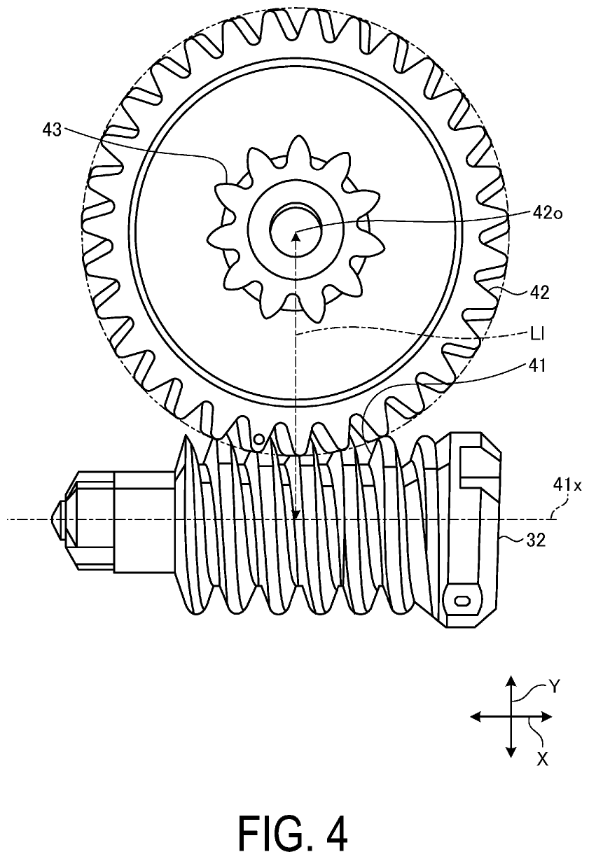

FIG. 3 is a cross-sectional view illustrating an inside of the housing 2 according to the embodiment. FIG. 4 is a plan view illustrating main parts of the gear box 1 according to the embodiment.

The gear box 1 according to the present embodiment can be suitably used as, for example, an actuator to be used for an air conditioning system for a vehicle or the like and can control a rotational operation of a louver for controlling air flow or the like.

As illustrated in FIGS. 1 to 4, the gear box 1 includes the housing 2, the motor 3, a drive transmission mechanism 4 including a plurality of gears, and a control unit not illustrated.

The housing 2 accommodates the motor 3 and the plurality of gears constituting the drive transmission mechanism 4. As illustrated in FIG. 2, the housing 2 is composed of a first part 2A and the second part 2B. Such a housing 2 is formed of, for example, a resin material. The housing 2 may be formed of a metal material. The motor 3 includes a frame including a first support part 21 and a second support part 22, an armature not illustrated, a magnet fixed to an inner surface of the frame and not illustrated, a commutator not illustrated, and a brush not illustrated. The housing 2 includes a third support part 23.

The first support part 21 supports a bearing 21a. The first support part 21 rotatably supports a part of the shaft 31 of the motor 3 at a worm 32 side via the bearing 21a. The second support part 22 supports a bearing not illustrated at an opposite side in the X-axis direction with respect to the bearing 21a. The second support part 22 supports other part of the shaft 31 of the motor 3 at a side opposite to the worm 32 side via the bearing not illustrated.

The first support part 21 forms an end part of the frame of the motor 3 and has a shape protruding in the longitudinal direction of the shaft 31.

The third support part 23 (support part) supports the first support part 21 via an elastic member 23a. The third support part 23 is a wall part provided inside the housing 2 and is formed in an L shape when viewed in a cross-section including the X-axis direction and the Y-axis direction. The third support part 23 supports a part of the shaft 31 of the motor 3 via the bearing 21a, the first support part 21, and the elastic member 23a.

The elastic member 23a is, for example, an O-ring and is formed in an annular shape with resin having elasticity. Such an elastic member 23a is provided in the housing 2. The elastic member 23a is formed of, for example, synthetic rubber but may be formed of a silicon-based resin material, a urethane-based resin material, or an epoxy-based resin material.

The motor 3 includes the shaft 31 rotatable. The motor 3 according to the present embodiment is, for example, a DC motor. The motor 3 may also be a motor including a brush, a brushless motor, or a stepping motor.

The drive transmission mechanism 4 is composed of a plurality of gears described below. Each of the gears is, for example, an injection molded product formed of a resin material. The drive transmission mechanism 4 transmits a driving force of the shaft 31 of the motor 3 to an output shaft 4J of an output gear 4E while converting a torque, the number of rotations, and a rotation direction by using the plurality of gears. The gear box 1 also includes a sensor not illustrated for detecting a rotation angle of the output shaft 4J.

The plurality of gears includes a first gear (gear) 41, a second gear 42, a third gear 43, a fourth gear 44, a plurality of transmission gears not illustrated, and the output-gear 4E.

The worm 32 includes the first gear 41. The worm 32 is fixed to the shaft 31 of the motor 3. An axial center 41x of the first gear 41 coincides with the axial center 3x of the shaft 31 of the motor 3. The worm 32 is, for example, an injection molded product formed of a resin material.

The second gear 42 is a helical gear configured to mesh with the first gear 41 formed in the worm 32.

The third gear 43 is formed coaxially with the second gear 42 as the helical gear. The size of the third gear 43 in a radial direction is smaller than the size of the second gear 42. The fourth gear 44 meshes with the third gear 43.

The first gear 41, the third gear 43, the fourth gear 44, the plurality of transmission gears not illustrated, and the output gear 4E are standard gears.

The standard gear is an involute gear having a tooth thickness of πm/2 on a reference pitch circle and a transfer coefficient of 0, where m is a module.

The second gear 42 as a helical gear is formed to satisfy −0.4<x<−0.1, where x is the transfer coefficient.

If the transfer coefficient x of the second gear 42 falls below −0.4, a tooth becomes thin, the strength may decrease, and thus the transfer coefficient x preferably exceeds −0.4. On the other hand, if the transfer coefficient x of the second gear 42 exceeds −0.1, the meshing ratio with the first gear 41 may decrease, and thus the transfer coefficient x preferably falls below −0.1.

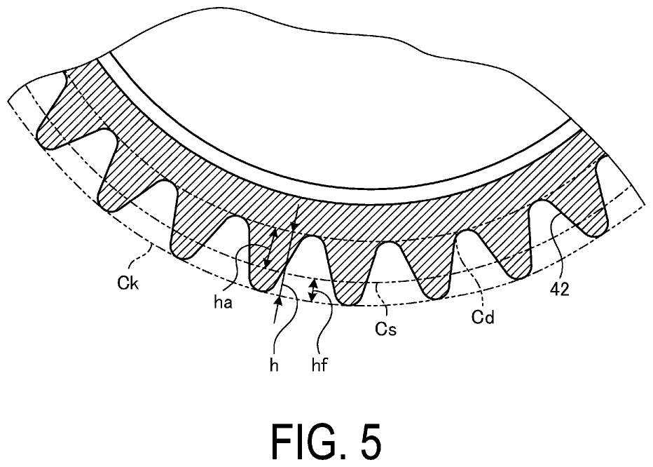

FIG. 5 is a cross-sectional view for explaining terms representing the shape of a gear. In FIG. 5, Cs denotes a reference pitch circle of the gear, Ck denotes an addendum circle of the gear, and Cd denotes a dedendum circle of the gear. In FIG. 5, a tooth depth is indicated by h. The tooth depth is the difference between the radius of the addendum circle Ck and the radius of the dedendum circle Cd A dedendum is indicated by ha. The dedendum is the difference between the radius of the reference pitch circle Cs and the radius of the dedendum circle Cd. An addendum is indicated by hf. The addendum is the difference between the radius of the addendum circle Ck and the radius of the reference pitch circle Cs. In such a case, an addendum coefficient k is expressed by the following equation.

k=hf/m

When the gear is a standard gear, the addendum coefficient k is 1.25, and the dedendum coefficient is 1.00, satisfying the following equations.

ha=1.00 m

hf=1.25 m

h=ha+hf=2.25 m

On the other hand, the addendum coefficient k of the second gear (helical gear) 42 according to the present embodiment satisfies 0.1<k<0.4. For example, the second gear (helical gear) 42 according to the present embodiment is formed as follows.

ha=1.00 m

hf=0.25 m

h=ha+hf=1.25 m

If the addendum coefficient k of the second gear 42 falls below 0.1, the meshing ratio with the first gear 41 does not change, but sound generated by the meshing between the first gear 41 and the second gear 42 may not be reduced. On the other hand, if the addendum coefficient k exceeds 0.4, the tip of the tooth of the second gear 42 becomes thin, the strength at the tip of the tooth decreases, and thus the tip of the tooth may be chipped or broken. Then, the addendum coefficient k of the second gear 42 according to the present embodiment is set in the range of 0.1<k<0.4.

The transfer coefficient x and the addendum coefficient k of the second gear 42 as the helical gear according to the present embodiment satisfy the following relationship.

−0.05<k−|x|<0.05

If the transfer coefficient x is simply negative, to maintain the meshing between the second gear 42 and the first gear 41, an inter-axial distance L1 between the axial center 41x of the first gear 41 and a rotational center 42o of the second gear 42 needs to be reduced. The gear box 1 according to the present embodiment has the addendum coefficient k and the transfer coefficient x satisfying −0.05<k−|x|<0.05, and as compared with the standard gear (the addendum coefficient k is 0, and the transfer coefficient x is 0), the first gear 41 and the second gear 42 can be meshed with each other without changing the inter-axial distance L1 between the axial center 41x of the first gear 41 and the rotational center 42o of the second gear 42 while having a predetermined meshing length. As a consequence, setting the addendum coefficient k and the transfer coefficient x in the range of −0.05<k−|x|<0.05 obtains the teeth of the second gear 42 having a predetermined strength, and the first gear 41 and the second gear 42 can have a predetermined meshing length. This can reduce sound generated between both the gears 41 and 42 at the time of driving the motor 3 and have the inter-axial distance L1 to some extent.

The control unit not illustrated comprehensively controls each part of the gear box 1. The gear box 1 having the above configuration rotates, when the motor 3 is driven by the control unit, the shaft 31 about the axial center 3x.

The rotation of the shaft 31 causes the first gear 41 formed in the worm 32 to rotate about the axial center 41x. The second gear 42 as the helical gear rotates with the rotation of the worm 32 and the first gear 41. The third gear 43 rotates together with the second gear 42 in the same direction as the rotation direction of the second gear 42.

The rotation of the third gear 43 causes the fourth gear 44 to rotate in a direction opposite to the rotation direction of the third gear 43. The output shaft 4J of the output gear 4E is rotated by the rotation of the fourth gear 44 via a transmission gear not illustrated.

The gear box 1 according to the present embodiment has the following configuration. The transfer coefficient of the second gear (helical gear) 42 with respect to the standard gear is x, the addendum coefficient of the second gear 42 is k, x satisfies −0.4<x<−0.1, and k satisfies 0.1<k<0.4. This can ensure the meshing between both the gears 41 and 42 while maintaining the strength of the teeth of the second gear 42 and have the inter-axial distance L1 to some extent. As a consequence, the gear box 1 according to the present embodiment can reduce sound generated between the first gear 41 formed in the worm 32 and the second gear (helical gear) 42 at the time of driving the motor 3.

The gear box 1 according to the present embodiment has the following configuration. The transfer coefficient of the second gear 42 is x, the addendum coefficient is k, and the following relationship is satisfied.

−0.05<k−|x|<0.05

That is, in the gear box 1 according to the present embodiment, the first gear 41 formed in the worm 32 and the second gear (helical gear) 42 are disposed to have the inter-axial distance L1 to some extent. This can further reduce sound generated between the first gear 41 formed in the worm 32 and the second gear (helical gear) 42 at the time of driving the motor 3.

The gear box 1 according to the present embodiment has the following configuration. The gear box 1 includes the elastic member 23a and the housing 2 including the third support part (support part) 23 supporting the motor 3 via the elastic member 23a. Therefore, the gear box 1 according to the present embodiment supports the motor 3 at the third support part 23 via the elastic member 23a, allowing vibration at the time of driving the motor 3 to be absorbed by an elastic force of the elastic member 23a. As a consequence, the gear box 1 according to the present embodiment can further reduce sound generated between the first gear 41 formed in the worm 32 and the second gear (helical gear) 42.

Note that the number of gears constituting the above-described drive transmission mechanism 4 can be appropriately changed in accordance with a torque or the like at the output shaft 4J of the output gear 4E.

The above embodiment describes the worm 32 and the plurality of gears constituting the drive transmission mechanism 4 as injection molded products formed of a resin material. However, the worm 32 and the plurality of gears according to the present embodiment are not limited to the product. The worm 32 and the plurality of gears may be formed of, for example, a metal material.

The present invention is not limited by the embodiment described above. A configuration obtained by appropriately combining the constituent elements of the above-described embodiment is also included in the present invention. Further effects and variations can be easily derived by a person skilled in the art. Thus, a wide range of aspects of the present invention is not limited to the embodiment described above and may be modified variously.

### REFERENCE SIGNS LIST

1 Gear box
2 Housing
23 Third support part (support part)
23a O-ring (elastic member)
3 Motor
31 Shaft
32 Worm
41 First gear (gear formed in worm)
41x Axial center
42 Second gear (helical gear)
x Transfer coefficient
k Addendum coefficient

1. A gear box, comprising:
a motor;
a worm pivotally supported by a shaft of the motor, a gear being formed at the worm; and
a helical gear configured to mesh with the gear of the worm, wherein
a transfer coefficient of the helical gear with respect to a standard gear is x,
an addendum coefficient of the helical gear is k,
x satisfies −0.4<x<−0.1, and
k satisfies 0.1<k<0.4.

2. The gear box according to claim 1, wherein −0.05<k−|x|<0.05 is satisfied.

3. The gear box according to claim 1, comprising:
an elastic member; and
a housing including a support part configured to support the motor via the elastic member.
